(19) United States
(12) Patent Application Publication
(10) Pub. No.: US 2023/0345590 A1
(43) Pub. Date: Oct. 26, 2023

(54) COOKING APPARATUS

(71) Applicant: Samsung Electronics Co., Ltd., Suwon-si (KR)

(72) Inventors: Sangjin JEONG, Suwon-si (KR); Sangwon YUN, Suwon-si (KR)

(21) Appl. No.: 18/177,627

(22) Filed: Mar. 2, 2023

Related U.S. Application Data
(63) Continuation of application No. PCT/KR2023/002206, filed on Feb. 15, 2023.

(30) Foreign Application Priority Data
Apr. 25, 2022 (KR) 10-2022-0050994
Jul. 4, 2022 (KR) 10-2022-0082155

(51) Int. Cl. H05B 6/64

(52) U.S. Cl. CPC H05B 6/6417

(57) ABSTRACT

The cooking apparatus includes a main body forming a cooking chamber, a door configured to open and close the cooking chamber, and a door lock including an interference member configured to interfere with a movement of the door while opening the cooking chamber, and a lock case configured to accommodate the interference member so as to be movable therein. The interference member is configured to move to an interference position for applying an interference with opening the door, an interference release position for releasing the interference of opening the door, and a function release position for restricting the interference of opening the door, the function release position is a position in which the interference member is supported by the lock case and in which movement of the interference member is restricted to the interference release position and the interference position.

### CROSS-REFERENCE TO RELATED APPLICATIONS

This application is a Bypass Continuation of International Patent Application No. PCT/KR2023/002206, filed Feb. 15, 2023, which claims priority to Korean Patent Application No. 10-2022-0050994, filed Apr. 25, 2022, and Korean Patent Application No. 10-2022-0082155, filed Jul. 4, 2022, the disclosures of which are incorporated by reference herein in their entirety

### BACKGROUND

### 1. Field

The disclosure relates to a cooking apparatus including a door.

### 2. Description of Related Art

A cooking apparatus is an appliance for heating and cooking an object to be cooked, such as a food, and refers to a device capable of providing various functions related to cooking, such as heating, thawing, drying, and sterilization of the object to be cooked. Examples of such a cooking apparatus include an oven such as a gas oven or an electric oven, a microwave heating device (hereinafter referred to as a microwave), a gas range, an electric range, an over the range (OTR), a gas grill, or an electric grill.

The microwave is a device that cooks a food by using frictional heat that is generated by disrupting a molecular arrangement of the food with an electromagnetic wave. The oven is a device that cooks a food by transferring heat directly to the food through a heat source such as a heater or by heating an inside of a cooking chamber.

A cooking chamber may be opened and closed by a door. The cooking apparatus may include an opening and closing device that selectively locks the door to allow the cooking chamber to maintain a closed state by the door. A user can unlock the door by operating the opening and closing device, and then open the door.

### SUMMARY

Therefore, it is an aspect of the disclosure to provide a cooking apparatus capable of increasing the safety of use.

It is another aspect of the disclosure to provide a cooking apparatus capable of increasing convenience of use.

Additional aspects of the disclosure will be set forth in part in the description which follows and, in part, will be obvious from the description, or may be learned by practice of the disclosure.

In accordance with an aspect of the disclosure a cooking apparatus includes a main body forming a cooking chamber, a door configured to open and close the cooking chamber, and a door lock including an interference member configured to interfere with a movement of the door while opening the cooking chamber, and a lock case configured to accommodate the interference member so as to be movable therein. The interference member is configured to move to an interference position for applying an interference with opening the door, an interference release position for releasing the interference of opening the door, and a function release position for restricting the interference of opening the door, the function release position is a position in which the interference member is supported by the lock case and in which movement of the interference member is restricted to the interference release position and the interference position.

The door lock may include a lever configured to move the interference member from the interference position to the interference release position.

The lever may be configured to move the interference member from the function release position to the interference release position as a force is applied to the lever that is greater than a force of the lock case supporting the interference member and the force applied to the lever is transferred to the interference member in the function release position.

The lever may be configured to move in a moving direction different from a moving direction of the interference member. The door lock may include an inclined insertion surface inclined with respect to the moving direction of the lever or the moving direction of the interference member so as to transfer the force applied to the lever to a force for moving the interference member.

The lever may be configured to push the interference member from the function release position to the interference release position as force applied to the lever is greater than a force of the lock case supporting the interference member and the force applied to the lever is transferred to the interference member in the function release position. The door lock may include a withdrawal guide inclined with respect to the moving direction of the lever or the moving direction of the interference member so as to transfer the force applied to the lever to a force for moving the interference member.

The door lock may include a lever elastic body configured to apply an elastic force to the lever in a direction in which the lever is separated from the lock case.

The lock case may include a lever guide extending along a moving direction of the lever to guide the movement of the lever.

The lock case may include a lever opening configured to allow at least a portion of the lever to protrude to an exterior of the lock case. In a state in which the interference member is moved to the interference release position as the lever presses the interference member, the lever opening may be configured to prevent the lever from moving in a direction in which the interference member is moved from the interference release position to the function release position.

The door lock may include an interference elastic body configured to apply an elastic force to the interference member to a direction in which the interference member is moved from the interference release position to the interference position.

The lock case may include a release supporter configured to support the interference member in response to the interference member being at the function release position. The interference member may include a release interference member configured to be supported by the release supporter.

The release supporter may be pressed and deformed by the release interference member while the interference member is moved between the interference release position and the function release position.

The door may be configured to move to a closed position for closing the cooking chamber, an open position for opening the cooking chamber, and a limit position in which the door is supported by the interference member while the interference member is at the interference position.

The interference member may include a door guide surface configured to be pressed and moved by the door so as to allow the door to be moved while the door is moved from the open position to the limit position or the closed position.

The lock case may include an interference member opening configured to allow at least a portion of the interference member to protrude to an exterior of the lock case toward the door in response to the door being at the closed position. The interference member may be configured to move from the interference release position to the function release position as the interference member is pressed through the interference member opening in a state in which the interference member is at the interference release position.

The cooking apparatus may further include a door latch configured to move in the door, a sensor configured to be in contact with the door latch, a controller electrically connected to the sensor, and a heating source electrically connected to the controller. The controller may be configured to control the heating source to stop an operation of the heating source in response to the door latch being separated from the sensor as the door is opened.

In accordance with another aspect of the disclosure a cooking apparatus includes a main body forming a cooking chamber, a door configured to open and close the cooking chamber, and a door lock including an interference member configured to interfere with a movement of the door while opening the cooking chamber, a lever configured to move the interference member, and a lock case configured to accommodate the interference member and the lever so as to be movable therein. The interference member is configured to move to an interference position for applying an interference with opening the door, an interference release position for releasing the interference of opening the door, and a function release position for restricting the interference of opening the door, the function release position is a position in which the interference member is supported by the lock case and in which movement of the interference member is restricted to the interference release position and the interference position. The lever is configured to move the interference member from the function release position to the interference release position as a force applied to the lever is greater than a force of the lock case supporting the interference member and the force applied to the lever is transferred to the interference member in the function release position.

The door lock may include an interference elastic body configured to apply an elastic force to the interference member to a direction in which the interference member is moved from the interference release position to the interference position.

The interference member may include a release interference member configured to be supported by the lock case in response to the interference member being at the function release position. The lock case may include a release supporter configured to be pressed and deformed by the release interference member while the interference member is moved between the interference release position and the function release position.

The lock case may include a lever opening configured to allow at least a portion of the lever to protrude to an exterior of the lock case. In a state in which the interference member is moved to the interference release position as the lever presses the interference member, the lever opening may be configured to prevent the lever from moving in a direction, in which the interference member is moved from the interference release position to the function release position.

The lock case may include an interference member opening configured to allow at least a portion of the interference member to protrude to an exterior of the lock case toward the door in a state in which the door is at a closed position for closing the cooking chamber. The interference member may be configured to move from the interference release position to the function release position as the interference member is pressed through the interference member opening in a state in which the interference member is at the interference release position.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 illustrates a cooking apparatus according to an embodiment of the disclosure;

FIG. 2 illustrates an exploded view of some components of the cooking apparatus of FIG. 1;

FIG. 3 illustrates a door locking device provided inside the cooking apparatus of FIG. 1;

FIG. 4 illustrates a state in which the door locking device of FIG. 3 locks a door;

FIG. 5 illustrates a state in which the door locking device of FIG. 3 unlocks the door;

FIG. 6 illustrates a connection relationship of a controller for controlling a heating source of FIG. 2 based on information detected by a sensor shown in FIGS. 4 and 5;

FIG. 7 illustrates a portion of a control panel and the door shown in FIG. 2;

FIG. 8 illustrates a door lock shown in FIG. 7;

FIG. 9 illustrates an exploded view of the door lock shown in FIG. 8;

FIG. 10 illustrates a cross section of a state in which an interference member of the door lock shown in FIG. 9 is at an interference position;

FIG. 11 illustrates a cross section of a state in which the interference member of the door lock shown in FIG. 9 is at an interference release position;

FIG. 12 illustrates a state in which the door is being closed in a state in which the interference member of the door lock shown in FIG. 9 is at the interference position;

FIG. 13 illustrates a process of moving the interference member of the door lock shown in FIG. 9 to a function release position;

FIG. 14 illustrates a state in which the interference member of the door lock shown in FIG. 9 is at the function release position;

FIG. 15 illustrates a state in which the door shown in FIG. 10 is at a limit position;

FIG. 16 illustrates a relationship between a door latch and a sensor in the state shown in FIG. 15;

FIG. 17 illustrates a door lock according to an embodiment;

FIG. 18 illustrates an exploded view of the door lock shown in FIG. 17;

FIG. 19 illustrates a cross section of a state in which an interference member of the door lock shown in FIG. 18 is at an interference position;

FIG. 20 illustrates a cross section of a state in which the interference member of the door lock shown in FIG. 18 is at an interference release position;

FIG. 21 illustrates a process of moving the interference member of the door lock shown in FIG. 18 to a function release position;

FIG. 22 illustrates a state in which the interference member of the door lock shown in FIG. 18 is at the function release position.

FIG. 23 illustrates a cooking apparatus according to an embodiment;

FIG. 24 illustrates a cooking apparatus according to an embodiment;

FIG. 25 illustrates a cooking apparatus according to an embodiment; and

FIG. 26 illustrates a cooking apparatus according to an embodiment.

### DETAILED DESCRIPTION

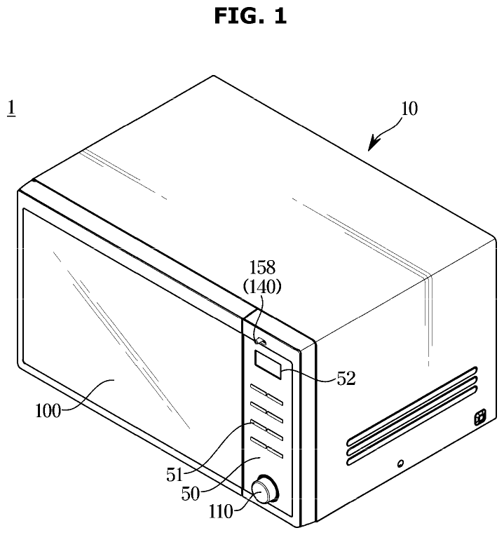

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless they are definitely different in a context.

The expressions “A or B,” “at least one of A and/or B,” or “one or more of A and/or B,” A, B or C,” “at least one of A, B and/or C,” or “one or more of A, B and/or C,” and the like used herein may include any and all combinations of one or more of the associated listed items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third component.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that when an element is referred to as being “connected”, “coupled”, “supported”, or “contacted” to another element, it can be directly or indirectly connected, coupled, supported, or contacted to the other element, wherein the indirect connection, couple, support or contact includes “connection, couple, support or contact via a third element”.

Throughout the description, when a member is “on” another member, this includes not only when the member is in contact with the other member, but also when there is another member between the two members.

The term of “and/or” includes a plurality of combinations of relevant items or any one item among a plurality of relevant items.

In the following detailed description, the terms of “front”, “rear”, “upper”, “lower”, “left”, “right” and the like may be defined by the drawings, but the shape and the location of the component is not limited by the term.

Hereinafter a cooking apparatus according to various embodiments of the disclosure will be described with reference to drawings.

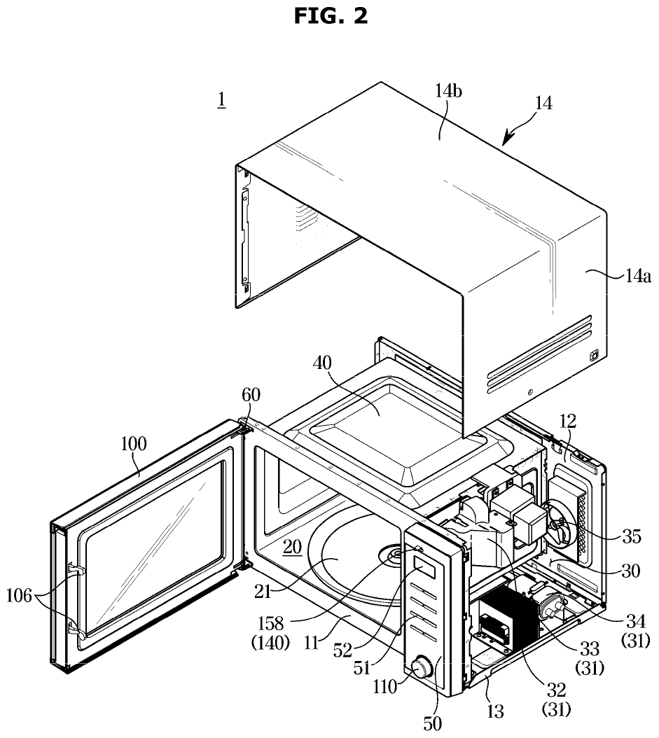

FIG. 1 illustrates a cooking apparatus according to an embodiment of the disclosure. FIG. 2 illustrates an exploded view of some components of the cooking apparatus of FIG. 1.

Referring to FIGS. 1 and 2, a cooking apparatus 1 may include a main body 10 forming an exterior thereof. The main body 10 may include a front panel 11, a rear panel 12, a bottom panel 13, and a cover 14. The cover 14 may be arranged between the front panel 11 and the rear panel 12. The cover 14 may include a side panel 14a and a top panel 14b. The side panel 14a and the top panel 14b may be integrally formed with each other. The side panel 14a and the top panel 14b may be provided as separate components.

The cooking apparatus 1 may include an inner case 40 forming a cooking chamber 20. The inner case 40 may be provided inside the main body 10. The inner case 40 may have a substantially rectangular parallelepiped shape with one side that is open. An electrical compartment 30 may be formed between the main body 10 and the inner case 40.

The cooking apparatus 1 may include a heating source 31 configured to cook a cooking object. For example, the heating source 31 may include a magnetron 32 provided to generate a high frequency to be supplied to the inside of the cooking chamber 20, and a high voltage transformer 33 and a high voltage capacitor 34 configured to apply a high voltage to the magnetron 32. The magnetron 32, the high voltage transformer 33, and the high voltage capacitor 34 may be located in the electrical compartment 30. The cooking apparatus 1 may include a cooling fan 35 configured to cool internal components of the electrical compartment 30. The cooling fan 35 may be located in the electrical compartment 30.

The cooking apparatus 1 may include a tray 21 arranged inside the cooking chamber 20 to accommodate a cooking object.

The cooking apparatus 1 may include a waveguide provided to guide the high frequency emitted from the magnetron 32 into the cooking chamber 20.

The cooking apparatus 1 may cook the cooking object by radiating high frequency waves into the cooking chamber 20 while the cooking object is accommodated in the tray 21. When the cooking apparatus 1 emits high-frequency waves into the cooking chamber 20, the cooking object may be cooked by frictional heat between the molecules. The frictional heat is generated as the arrangement of the molecules of the water contained in the cooking object accommodated in the tray 21 is repeatedly converted.

For example, the heating source 31 may include a heater configured to heat the inside of the cooking chamber 20.

The cooking apparatus 1 may include a door 100 coupled to the front panel 11 of the main body 10 to open and close the cooking chamber 20. The door 100 may be rotatably coupled to the main body 10. A rotation operation of the door 100 that is to open and close the cooking chamber 20 may be defined as being included in a movement of the door 100. At least a portion of the door 100 may include a transparent or translucent material to allow the inside of the cooking chamber 20 to be seen.

The cooking apparatus 1 may include a control panel 50 including an inputter 51 configured to receive a user's input and/or a display 52 provided to display information. The control panel 50 may be coupled to the front panel 11 of the main body 10. The control panel 50 may be arranged on one side of the door 100. The control panel 50 may be positioned at a first end of the front panel 11 that is opposite to a second end of the front panel 11 in which a hinge 60 rotatably supporting the door 100 is positioned. The control panel 50 may be included in the main body 10.

The cooking apparatus 1 may include a button 110 mounted on the control panel 50. The cooking apparatus 1 may be configured to open the door 100 by operating a button 110 when the door 100 is positioned to close the cooking chamber 20.

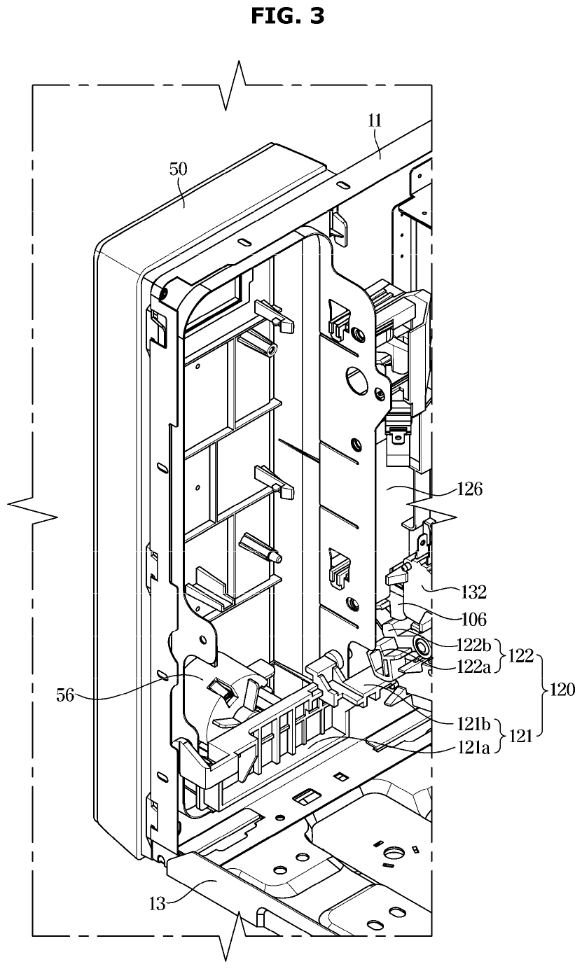

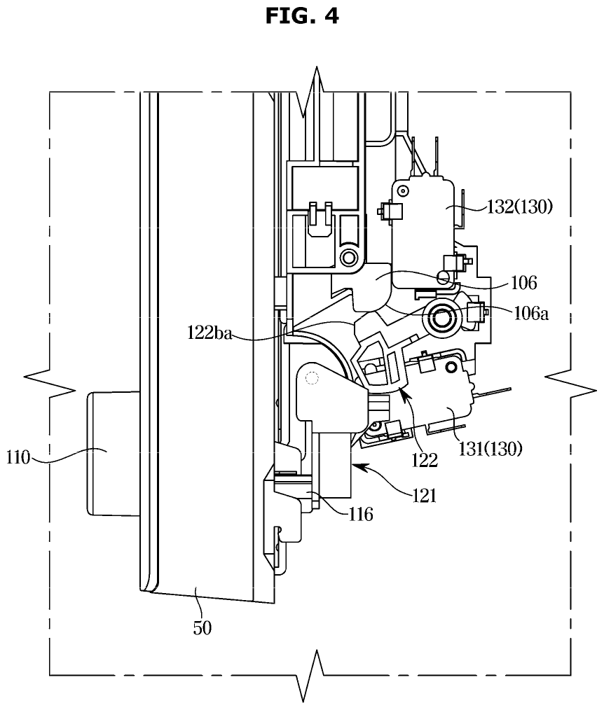

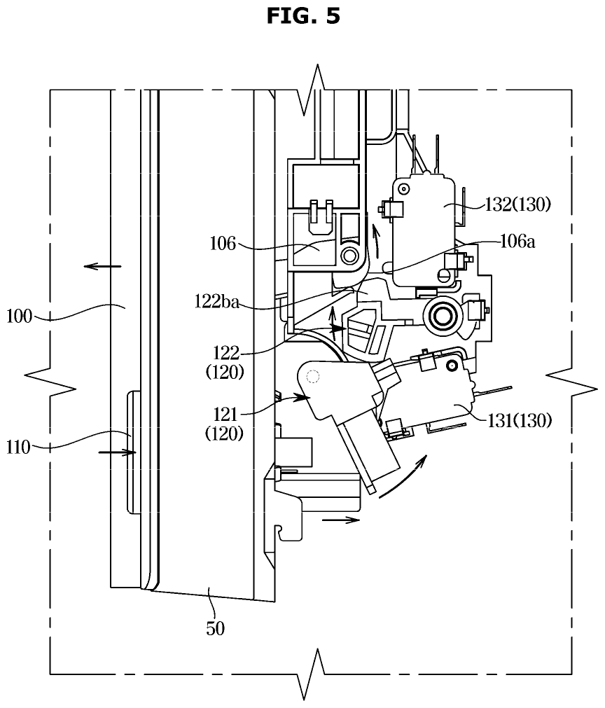

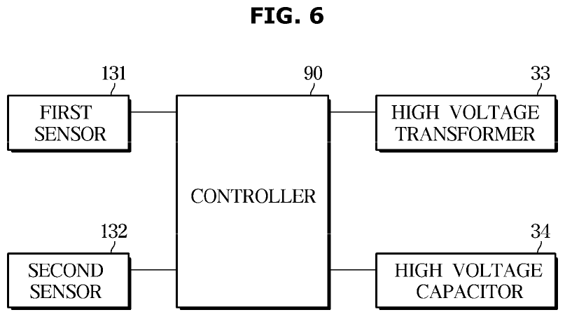

FIG. 3 illustrates a door locking device provided inside the cooking apparatus of FIG. 1. FIG. 4 illustrates a state in which the door locking device of FIG. 3 locks a door. FIG. 5 illustrates a state in which the door locking device of FIG. 3 unlocks the door. FIG. 6 illustrates a connection relationship of a controller for controlling a heating source of FIG. 2 based on information detected by a sensor shown in FIGS. 4 and 5.

Configurations of the button 110 and an opening and closing device 120 configured to open the door 100 will be described with reference to FIGS. 3 to 6.

The cooking apparatus 1 may include the button 110 configured to operate the opening and closing device 120. The button 110 may be provided to be moved with respect to the control panel 50. The control panel 50 may include a button mounting member 56 to which the button 110 is mounted. The button 110 may be movably mounted on the button mounting member 56.

The cooking apparatus 1 may include the opening and closing device 120 configured to selectively limit the movement of the door 100 when the door 100 is at a position for closing the cooking chamber 20. The cooking apparatus 1 may include a door latch 106 movably mounted on the door 100. The opening and closing device 120 may be configured to move the door latch 106.

The opening and closing device 120 may include a first transfer member 121 provided to be rotatable by being pressed by the button 110, and a second transfer member 122 member provided to be rotatable in response to the rotation of the first transfer member 121.

The first transfer member 121 may be rotatably mounted on the front panel 11. The first transfer member 121 may be rotatably mounted on the control panel 50. When the first transfer member 121 is rotated by being pressed by a button pusher 116 of the button 110, the first transfer member 121 may rotate the second transfer member 122.

The first transfer member 121 may include a first transfer body 121a provided to be pressed by the button 110 and a first pusher 121b provided to rotate the second transfer member 122. As the first transfer body 121a is rotated by being pressed by the button 110, the first pusher 121b may rotate the second transfer member 122. The first transfer body 121a may be provided to be in contact with the button 110. The first pusher 121b may be provided to be in contact with the second transfer member 122.

The second transfer member 122 may be rotatably mounted on the front panel 11. The second transfer member 122 may be rotatably mounted on a case 126 of the opening and closing device 120 mounted on the front panel 11. When the second transfer member 122 is rotated by the first transfer member 121, the second transfer member 122 may move the door latch 106 to allow the door 100 to be opened.

The second transfer member 122 may include a second transfer body 122a provided to be pressed by the first transfer member 121 and a second pusher 122b provided to move the door latch 106. As for the second transfer member 122, as the second transfer body 122a is rotated by being pressed by the first transfer member 121, the second pusher 122b may move the door latch 106. The second transfer body 122a may be provided to be in contact with the first pusher 121b of the first transfer member 121. The second pusher 122b may be provided to be in contact with the door latch 106.

The second pusher 122b of the second transfer member 122 may include a push surface 122ba provided to move the door latch 106 to a direction in which the door 100 is opened when the first transfer member 121 and the second transfer member 122 are rotated as the button 110 is pressed. The push surface 122ba may have a curved shape that is convex toward the door latch 106. When the first transfer member 121 is rotated as the button 110 is pressed, the push surface 122ba may lift the door latch 106, and also push the door latch 106 to the direction in which the door 100 is opened. As the push surface 122ba pushes the door latch 106, the door 100 may be opened to a degree that a user can grip.

The door latch 106 may include a latch guide surface 106a provided to be in contact with the push surface 122ba of the second pusher 122b of the second transfer member 122. When the first transfer member 121 and the second transfer member 122 are rotated as the button 110 is pressed, the latch guide surface 106a may be pressed by the push surface 122ba to the direction in which the door 100 is opened. The latch guide surface 106a may have a curved shape that is convex toward the second transfer member 122.

Referring to FIG. 6, the cooking apparatus 1 may include a sensor 130. The sensor 130 may include a first sensor 131 and/or a second sensor 132. The first sensor 131 may be provided to be in contact with the second transfer member 122. The second sensor 132 may be provided to be in contact with the door latch 106. The first sensor 131 may transmit a signal for stopping the operation of the heating source 31 to the controller 90 when the first sensor 131 is separated from the second transfer member 122 as the second transfer member 122 is rotated. The second sensor 132 may transmit a signal for stopping the operation of the heating source 31 to the controller 90 when the second sensor 132 is separated from the door latch 106 as the door latch 106 is moved. The controller 90 may be configured to control the high voltage transformer 33 and/or the high voltage capacitor 34.

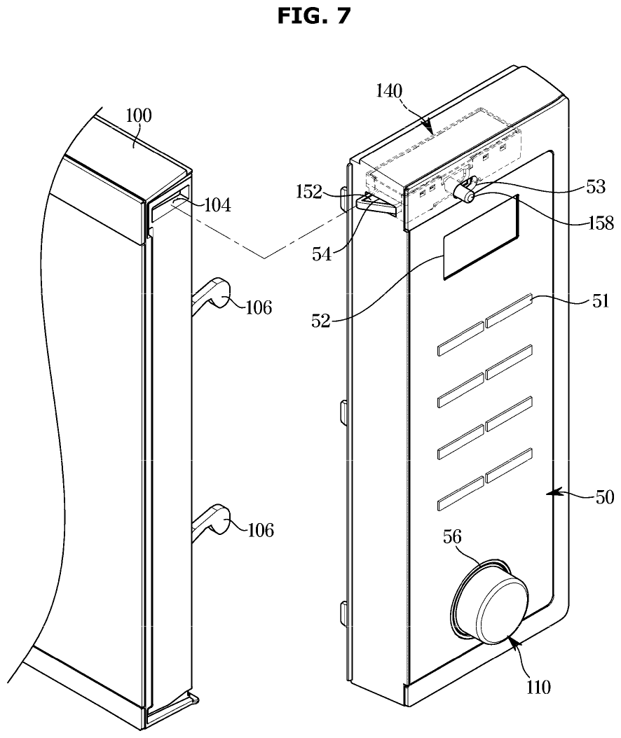

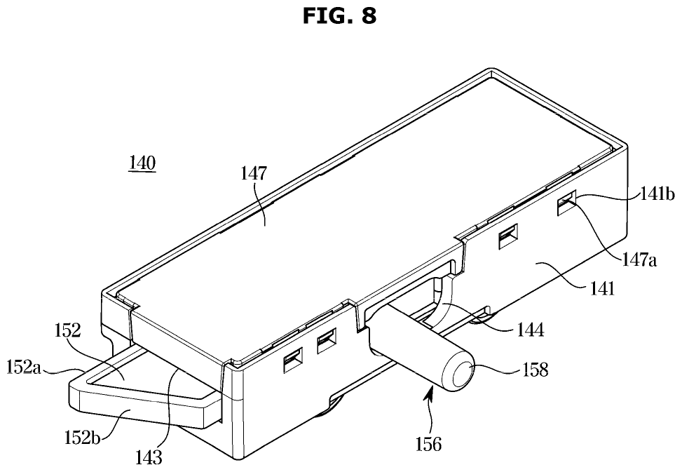

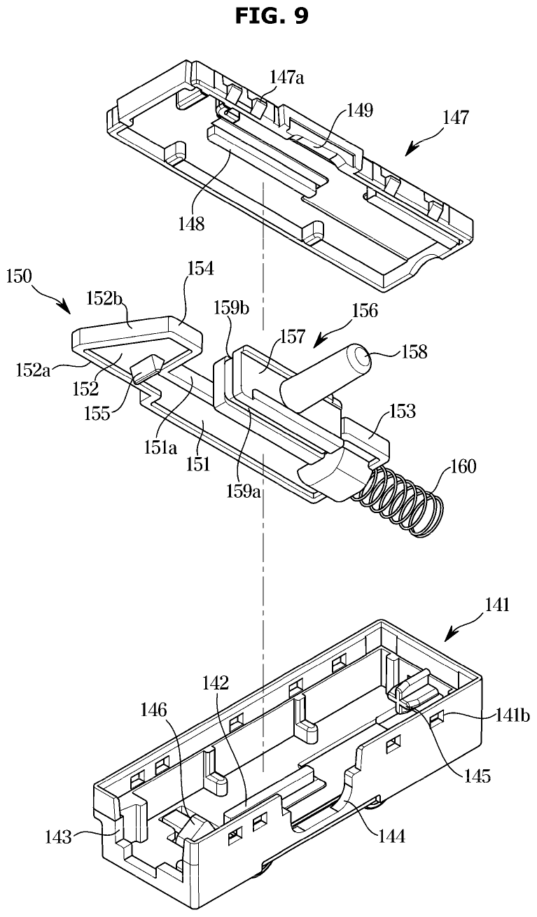

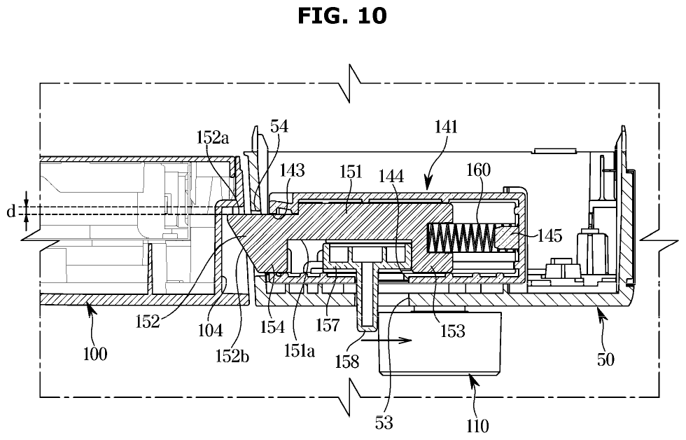

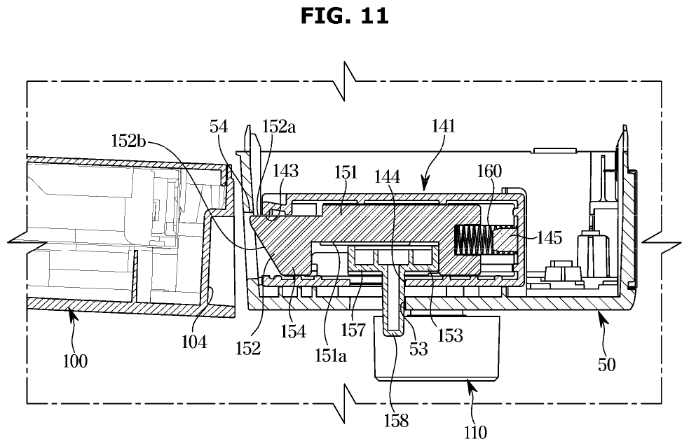

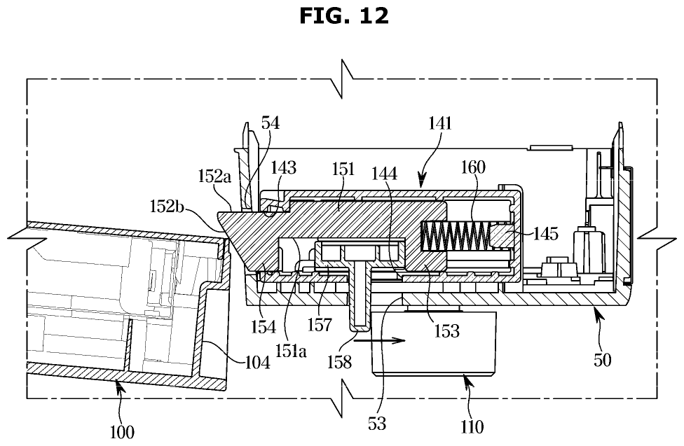

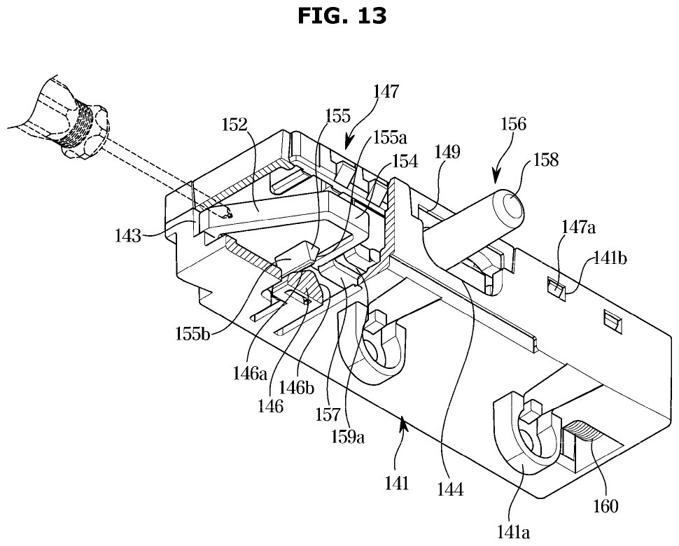

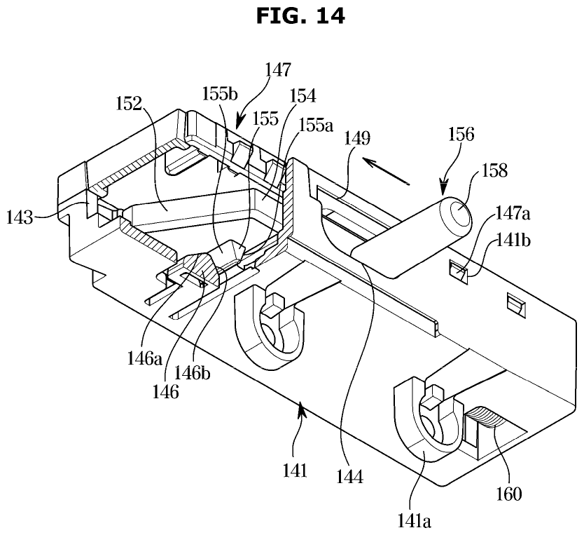

FIG. 7 illustrates a portion of a control panel and the door shown in FIG. 2. FIG. 8 illustrates a door lock shown in FIG. 7. FIG. 9 illustrates an exploded view of the door lock shown in FIG. 8. FIG. 10 illustrates a cross section of a state in which an interference member of the door lock shown in FIG. 9 is at an interference position. FIG. 11 illustrates a cross section of a state in which the interference member of the door lock shown in FIG. 9 is at an interference release position. FIG. 12 illustrates a state in which the door is being closed in a state in which the interference member of the door lock shown in FIG. 9 is at the interference position. FIG. 13 illustrates a process of moving the interference member of the door lock shown in FIG. 9 to a function release position. FIG. 14 illustrates a state in which the interference member of the door lock shown in FIG. 9 is at the function release position.

A door lock 140 of the cooking apparatus 1 according to an embodiment will be described with reference to FIGS. 7 to 14. The door lock 140 may be provided to limit the opening of the door 100. When a position at which the door 100 closes the cooking chamber 20 is referred to as a closed position and a position at which the door 100 opens the cooking chamber 20 is referred to as an open position, the door lock 140 may interfere the door 100 so as to allow the door 100 to be positioned at a limit position between the closed position and the open position.

The door 100 may include a door guide 104 formed to allow the opening of the door 100 to interfere with the door lock 140. The door guide 104 may be located at a portion of the door 100 facing the control panel 50 when the door 100 is at the closed position.

Referring to FIGS. 7 to 9, the door lock 140 may include a lock body 141. The lock body 141 may accommodate an interference member 150 to be movable. The lock body 141 may guide the movement of the interference member 150. The lock body 141 may accommodate a lever 156 to be movable. The lock body 141 may guide the movement of the lever 156. The lock body 141 may include a body fixer 141a (refer to FIGS. 13 and 14) for being fixed to the control panel 50. The lock body 141 may include a body coupler 141b for coupling with a lock cover 147. It is possible to define the lock cases 141 and 147 by including the lock body 141 and the lock cover 147.

The lock body 141 may include a body guide 142 provided to guide the movement of the lever 156. The body guide 142 may be located inside the lock body 141. The body guide 142 may protrude from an inner surface of the lock body 141. The body guide 142 may extend along a moving direction of the lever 156. The body guide 142 may be connected to a body rail 159a of the lever 156. The body guide 142 may be movably inserted into the body rail 159a.

The lock body 141 may include an interference member opening 143. The interference member opening 143 may be formed to allow at least a portion of the interference member 150 to pass therethrough. The interference member opening 143 may be located at a portion of the door lock 140 facing the door 100 when the door lock 140 is mounted on the control panel 50. The interference member opening 143 may be provided to correspond to an interference opening 54 formed in the control panel 50. The interference member opening 143 may guide the movement of the interference member 150.

The lock body 141 may include a lever opening 144. The lever opening 144 may be formed to allow at least a portion of the lever 156 to pass therethrough. The lever opening 144 may allow a manipulator 158 of the lever 156 to protrude to an exterior of the control panel 50. When the door lock 140 is mounted on the control panel 50, the lever opening 144 may be located at a portion of the door lock 140 facing forward. The lever opening 144 may be provided to correspond to a manipulation opening 53 formed in the control panel 50. The lever opening 144 may guide the movement of lever 156.

The lock body 141 may include an elastic body supporter 145. The elastic body supporter 145 may support an interference elastic body 160. The elastic body supporter 145 may be located at a first end of the lock body 141 opposite to a second end of the lock body 141, in which the interference member opening 143 is located. The elastic body supporter 145 may extend along a direction in which the interference elastic body 160 applies the elastic force to the interference member 150. The elastic body supporter 145 may protrude from the inner surface of the lock body 141. The elastic body supporter 145 may be provided to limit a movement in a direction perpendicular to the elastic force applied to the interference member 150 by the interference elastic body 160. The elastic body supporter 145 may be provided to support the first end of the lock body 141 opposite to the second end of the lock body 141 in which the interference elastic body 160 supports the interference member 150.

The lock body 141 may include a release supporter 146. The release supporter 146 may protrude toward the inside of the lock body 141. The release supporter 146 may extend from the inner surface of the lock body 141 toward the inside. The release supporter 146 may be provided to interfere with a release interference member 155 of the interference member 150. The release supporter 146 may protrude toward the interference member 150. The release supporter 146 may be arranged adjacent to the second end of the lock body 141 in which the interference member opening 143 is located. The release supporter 146 may be provided to be deformable.

The door lock 140 may include the lock cover 147. The lock cover 147 may cover one open side of the lock body 141. The lock cover 147 may include a cover coupler 147a for coupling with the lock body 141. The cover coupler 147a may be coupled to the body coupler 141b of the lock body 141.

The lock cover 147 may include a cover guide 148 provided to guide the movement of the lever 156. The cover guide 148 may be located inside the lock cover 147. The cover guide 148 may protrude from an inner surface of the lock cover 147. The cover guide 148 may extend along the moving direction of the lever 156. The cover guide 148 may be connected to a cover rail 159b of the lever 156. The cover guide 148 may be movably inserted into the cover rail 159b.

The body guide 142 and/or cover guide 148 may be referred to as a lever guide.

The lock cover 147 may include an opening guide 149. The opening guide 149 may be provided to correspond to the lever opening 144 of the lock body 141. The opening guide 149 may be provided to guide the movement of the lever 156. Together with the lever opening 144, the opening guide 149 may be provided to guide the movement of the manipulator 158 of the lever 156.

The door lock 140 may include the interference member 150 movably accommodated inside the lock body 141. At least one portion of the interference member 150 may be provided to protrude out of the lock body 141. The interference member 150 may move to an interference position arranged to interfere with the opening of the door 100 or an interference release position arranged not to interfere with the door 100 to allow the door 100 to be opened. The interference member 150 may move to the interference position arranged to interfere with the opening of the door 100 or the interference release position arranged to release the interference of the door 100.

A first end of the interference member 150 may be supported by the interference elastic body 160. The interference member 150 may be elastically supported by the a first end of the interference elastic body 160 opposite to a second end of the interference elastic body 160, which is supported by the lock body 141. By the interference elastic body 160, the interference member 150 may receive an elastic force in a direction of being separated from the lock body 141. The interference elastic body 160 may apply the elastic force to the interference member 150 in a direction in which the interference member 150 moves from the interference release position to the interference position.

The interference member 150 may include an interference member body 151 extending along the moving direction of the interference member 150. A door interference member 152 may be provided at an end of the interference member body 151. The door interference member 152 may be located at the end of the interference member body 151 adjacent to the door 100 when the door lock 140 is mounted on the control panel 50. The door interference member 152 may be provided to pass through the interference member opening 143. The door interference member 152 may be provided to pass through the interference opening 54. When the interference member 150 is at the interference position, at least a portion of the door interference member 152 may be accommodated inside the door guide 104. When the door interference member 152 is at the interference position and the door 100 is at the limit position, the door guide 104 may be come into contact with the door interference member 152 and may be supported by the door interference member 152.

The door interference member 152 may include a door interference surface 152a formed to interfere with the door 100 when the door 100 is opened. When the interference member 150 is at the interference position, the door interference surface 152a may be in contact with the door guide 104 formed on the door 100 and may limit the opening of the door 100. When the door 100 is opened while the interference member 150 is at the interference position, the door interference surface 152a may support the door guide 104 of the door 100 and prevent the opening of the door 100.

The door interference member 152 may include a door guide surface 152b that guides the movement of the door 100 without interfering with the door 100 when the door 100 moves from the open position to the limit position or the closed position. The door guide surface 152b may be inclined in a direction away from the door 100 as the door 100 is opened. The door guide surface 152b may be pressed by the door 100 when the door 100 moves from the open position to the limit position or the closed position, and thus the interference member 150 may move toward the inside of the lock body 141.

The interference member 150 may include an insertion guide 153 provided to be pressed by the lever 156. The insertion guide 153 may be located at the the first end of the interference member 150 opposite to a second end of the interference member 150 in which the door interference member 152 is located. The insertion guide 153 may be arranged adjacent to the interference elastic body 160. The insertion guide 153 may be pushed by the lever 156 when the lever 156 moves the interference member 150 from the interference position to the interference release position. As the insertion guide 153 is pushed by the lever 156, the interference member 150 may be moved from the interference position to the interference release position.

The interference member 150 may include a withdrawal guide 154 provided to be pressed by the lever 156. The withdrawal guide 154 may be positioned adjacent to the second end of the interference member 150 in which the door interference member 152 is located. The withdrawal guide 154 may be arranged adjacent to the door interference member 152. The withdrawal guide 154 may be pushed by the lever 156 when the lever 156 is moved to move the interference member 150 from the function release position to the interference release position or the interference position. As the withdrawal guide 154 is pushed by the lever 156, the interference member 150 may be moved from the function release position to the interference release position or the interference position.

The interference member body 151 may include a lever support surface 151a provided to support the lever 156. The lever support surface 151a may guide the movement of the lever 156 to allow the lever 156 to be movable along the moving direction of the interference member 150. The lever support surface 151a may be provided to limit the movement of the lever 156 toward the inside of the lock body 141. Together with the insertion guide 153 and/or the withdrawal guide 154, the lever support surface 151a may form a space in which the lever 156 is movable.

The interference member 150 may include a release interference member 155 provided to interfere with the release supporter 146 of the lock body 141. The release interference member 155 may protrude from the interference member 150. The release interference member 155 may be arranged adjacent to the second end of the interference member 150 in which the door interference member 152 is located. The release interference member 155 may interfere with the release supporter 146 while the interference member 150 is moved between the interference release position and the function release position.

The door lock 140 may include the lever 156 provided to move the interference member 150. The lever 156 may be configured to be moved inside the lock body 141. The lever 156 may include a lever body 157. The lever 156 may be moved in a direction substantially parallel to the moving direction of the interference member 150.

The lever body 157 may include the body rail 159a provided to be guided by the body guide 142. The lever body 157 may include the cover rail 159b provided to be guided by the cover guide 148. The lever body 157 may be located inside the lock body 141. The lever body 157 may be provided to push the insertion guide 153. The lever body 157 may be provided to push the withdrawal guide 154.

The lever 156 may include the manipulator 158 provided to protrude to an exterior of the door lock 140. The manipulator 158 may extend from the lever body 157. The manipulator 158 may be provided to pass through the lever opening 144. The manipulator 158 may be provided to pass through the manipulation opening 53. The manipulator 158 may be provided to allow a user to operate the manipulator 158. The manipulator 158 may be exposed to the outside of the control panel 50. The lever 156 may be provided to be movable as the manipulator 158 is operated.

The manipulation opening 53 may be provided to limit a movement range of the lever 156. The manipulation opening 53 may be provided to allow the lever 156 to move the interference member 150 from the interference position to the interference release position or to move the interference member 150 from the function release position to the interference release position. The movement range of the lever 156 may be limited by the manipulation opening 53.

The door lock 140 may include the interference elastic body 160 provided to elastically support the interference member 150. The interference elastic body 160 may be mounted on the elastic body supporter 145. The second end of the interference elastic body 160 may be supported by the lock body 141. The first end of the interference elastic body 160, which is opposite to the second end of the interference elastic body 160 supported by the lock body 141, may be supported by the interference member 150.

The interference position and the interference release position of the interference member 150 will be described with reference to FIGS. 10 to 12.

Referring to FIG. 10, the interference member 150 may be at the interference position that may interfere with the opening of the door 100. When the interference member 150 is at the interference position, the door 100 may be moved from the closed position to the limit position. When the interference member 150 is at the interference position, at least a portion of the door interference member 152 of the interference member 150 may be accommodated in the door guide 104. As the at least a portion of the door interference member 152 is accommodated in the door guide 104, the door 100 may interfere with the door lock 140 when the door 100 is moved from the closed position to the open position. When the door 100 is moved from the closed position to the open position, the door guide 104 of the door 100 may interfere with the door interference member 152 of the door lock 140.

Referring to FIG. 11, the interference member 150 may be at the interference release position for releasing the interference with the opening of the door 100. A user can move the interference member 150 to the interference release position by moving the manipulator 158 of the lever 156. While the manipulator 158 of the lever 156 is moved until the movement of the manipulator 158 is limited by a portion of the lever opening 144, the manipulator 158 may move the interference member 150 into the lock body 141.

In a state in which the interference member 150 is moved to the interference release position as the lever 156 presses the interference member 150, the lever opening 144 may prevent the movement of the lever 156 in the direction, in which the interference member 150 is moved from the interference release position to the function release position. Accordingly, even when a user operates the lever 156, the user cannot move the interference member 150 to the function release position. In a state in which the interference member 150 is at the interference release position, the interference member 150 may be moved from the interference release position to the function release position by being pressed through the interference member opening 143.

When the interference member 150 is at the interference release position, the door 100 may be moved from the closed position to the open position. When the interference member 150 is at the interference release position, the door interference member 152 of the interference member 150 may be separated from the door guide 104. When the interference member 150 is at the interference release position, the door interference member 152 of the interference member 150 may be moved into the lock body 141. Because the door interference member 152 is separated from the door guide 104, the door 100 may not interfere with the door lock 140 when being moved from the closed position to the open position. When the door 100 is moved from the closed position to the open position, the door guide 104 of the door 100 may not interfere with the door interference member 152 of the door lock 140.

In a state shown in FIG. 11, when a user removes the force applied to the manipulator 158 of the lever 156, the interference member 150 may be moved in the direction of being separated from the lock body 141 by the elastic force of the interference elastic body 160. The door interference member 152 of the interference member 150 may protrude to an exterior of the lock body 141 by the elastic force of the interference elastic body 160. The interference member 150 may be moved in a direction of being withdrawn from the lock body 141 until the movement of the manipulator 158 of the lever 156 is limited by a portion of the lever opening 144, and the interference member 150 may be moved to the interference position that interferes with the opening of the door 100.

With the configuration, in the cooking apparatus 1 according to an embodiment, the opening of the door 100 may be limited by the door lock 140 even when the locking of the door 100 is released as the opening and closing device 120 is operated due to the movement of the button 110. Accordingly, it is possible to increase the safety of use. The cooking apparatus 1 according to an embodiment may unlock the door 100 by operating the opening and closing device 120 by moving the button 110 and then separate the door interference member 152 of the interference member 150 from the door guide 104 by moving the manipulator 158 of the lever 156 of the door lock 140, thereby opening the door 100. Accordingly, it is possible to increase the safety of use. In the cooking apparatus 1 according to an embodiment, because the door 100 is double-locked by the opening and closing device 120 and the door lock 140, it is possible to increase the safety of use.

Referring to FIG. 12, as the force applied to the manipulator 158 of the lever 156 is removed, the door 100 is moved from the open position to the limit position or the closed position while the interference member 150 is at the interference position. At this time, the door 100 may be moved while pushing the door interference member 152 of the interference member 150 of the door lock 140. When the door 100 is moved from the open position to the limit position or the closed position while the interference member 150 is at the interference position, the door 100 may be moved by being in contact with the door guide surface 152b of the door interference member 152. When the door 100 is moved from the open position to the limit position or the closed position while the interference member 150 is at the interference position, the door interference member 152 may be pressed by the door 100 and moved to the inside of the lock body 141. After the door 100 is moved from the open position to the limit position or the closed position, the interference member 150 may be moved to the interference position by the elastic force of the interference elastic body 160.

With the configuration, the cooking apparatus 1 according to an embodiment may prevent the movement of the door 100 from being limited by the door lock 140 while moving from the open position to the limit position or the closed position.

The function release position of the interference member 150 of the door lock 140 will be described with reference to FIGS. 13 and 14. The interference member 150 of the door lock 140 may be moved to the function release position in which the door interference member 152 is fixed to the inside of the lock body 141 so as not to protrude to an exterior of the lock body 141.

Referring to FIG. 13, when a user does not want to double lock the door 100 by using the opening and closing device 120 and the door lock 140, the user can operate the door lock 140 to release the function of the door lock 140. A user can press the interference member 150 to a direction toward the inside of the lock body 141 by using a tool such as a screwdriver. From the interference release position, the interference member 150 may be further moved to a direction opposite to the interference position. The interference member 150 may be moved from the interference release position to the function release position. While the interference member 150 is moved from the interference release position to the function release position, the release interference member 155 of the interference member 150 may interfere with the release supporter 146 of the lock body 141. While the interference member 150 is moved from the interference release position to the function release position, the first interference surface 155a of the release interference member 155 may be in contact with the first support surface 146a of the release supporter 146. Because the release supporter 146 is deformable, the release interference member 155 may deform the release supporter 146 and may be moved in a direction in which the interference elastic body 160 contracts.

Referring to FIG. 14, when the release interference member 155 is moved until the first interference surface 155a of the release interference member 155 is released from contact with the first support surface 146a of the release supporter 146, the deformed release supporter 146 may be restored to its original state. As the release supporter 146 is restored, the second interference surface 155b of the release interference member 155 may come into contact with the second support surface 146b of the release supporter 146. The second interference surface 155b of the release interference member 155 may be supported on the second support surface 146b of the release supporter 146. The release supporter 146 may support the release interference member 155 to a direction opposite to the direction in which the interference member 150 protrudes to an exterior of the lock body 141. As the release supporter 146 supports the release interference member 155, the interference member 150 may maintain the function release position.

When a user wants to use the released function of the door lock 140 again, the user can operate the manipulator 158 of the lever 156 of the door lock 140 to move the interference member 150 from the function release position to the interference release position. The user may apply a force to the manipulator 158 of the lever 156 to allow a force, which is greater than a force with which the release supporter 146 supports the release interference member 155, to be applied to the interference member 150. While the interference member 150 is moved from the function release position to the interference release position, the release supporter 146 may be deformed by the release interference member 155. When the release interference member 155 is moved until the second interference surface 155b of the release interference member 155 is released from contact with the second support surface 146b of the release supporter 146, the deformed release supporter 146 may be restored to its original state. The interference member 150 may be moved to the interference position by the elastic force of the interference elastic body 160.

With the configuration, the cooking apparatus 1 may selectively use the function of the door lock 140, and thus convenience of use may be improved.

The interference opening 54 may be formed in such a size that a user cannot push the interference member 150 to the function release position with a finger. The cooking apparatus 1 according to an embodiment is provided to allow the interference member 150 to be moved to the function release position through the interference opening 54 using a tool having a predetermined size or less. In the cooking apparatus 1 according to an embodiment, the user needs to use a tool having a predetermined size or less to manipulate the door lock 140 so as to release the function, and thus it is possible to prevent a state in which a user unintentionally releases the function of the door lock 140.

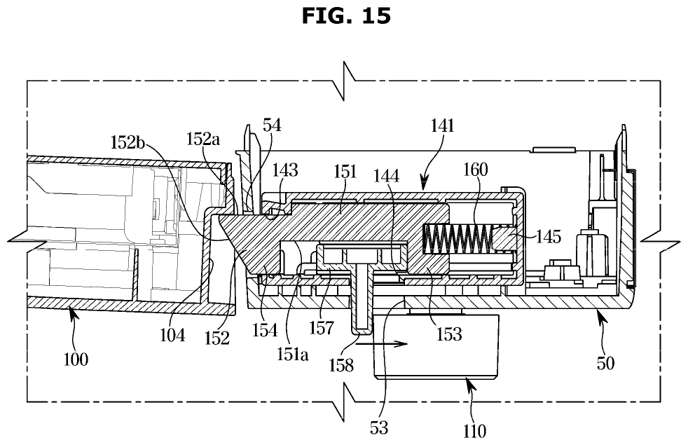

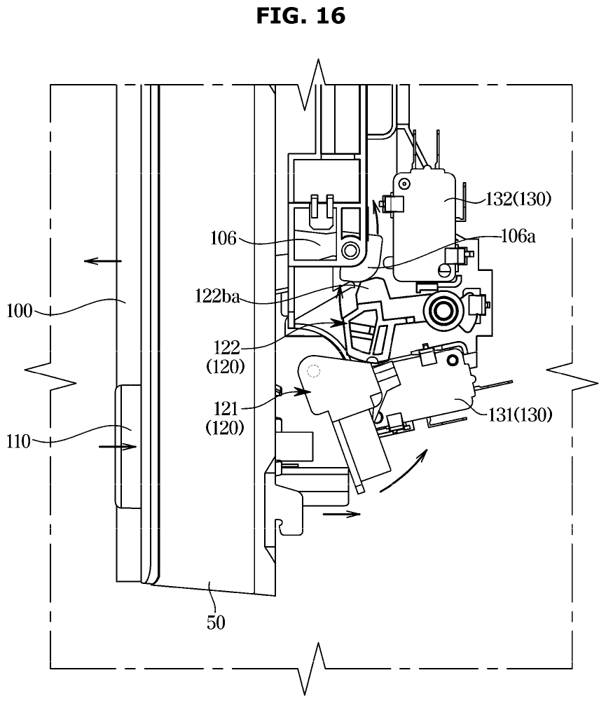

FIG. 15 illustrates a state in which the door shown in FIG. 10 is at a limit position. FIG. 16 illustrates a relationship between a door latch and a sensor in the state shown in FIG. 15.

A relationship between the door latch and the sensor when the door is at the limit position will be described with reference to FIGS. 15 and 16.

Referring to FIGS. 10 and 15, the door guide 104 of the door 100 and the door interference member 152 of the door lock 140 may be spaced apart by a predetermined distance (d) so as to allow the door 100 to move from the closed position to the interference position. The cooking chamber 20 in a state, in which the door 100 is at the interference position, may be defined as a somewhat open state rather than a completely closed state. The cooking chamber 20 may be opened to some extent when the door 100 is at the interference position, and thus the cooking apparatus 1 according to an embodiment may be configured to stop the operation of the heating source 31 that is arranged in the cooking chamber 20 to heat the cooking object.

Referring to FIGS. 4 and 16, when the opening and closing device 120 is operated as the button 110 is pressed, the opening and closing device 120 may move the door latch 106 toward the direction in which the door 100 is opened. When the interference member 150 of the door lock 140 is at the interference position, the door 100 may be moved from the closed position to the limit position. When the door 100 is moved to the limit position, the door latch 106 may be spaced apart from the second sensor 132. As the door latch 106 is separated from the second sensor 132, the controller 90 may stop the operation of the heating source 31 based on information received from the second sensor 132.

When the door 100 is at the interference position in which the cooking chamber 20 is opened to some extent, the cooking apparatus 1 according to an embodiment may be configured to stop the operation of the heating source 31 that is arranged in the cooking chamber 20 to heat the cooking object. Accordingly, it is possible to increase the safety of use. In the cooking apparatus 1 according to an embodiment, when the door 100 is at the closed position, the contact between the door latch 106 and the second sensor 132 may be released, and thus the operation of the heating source 31 may be stopped. Accordingly, it is possible to increase the safety of use.

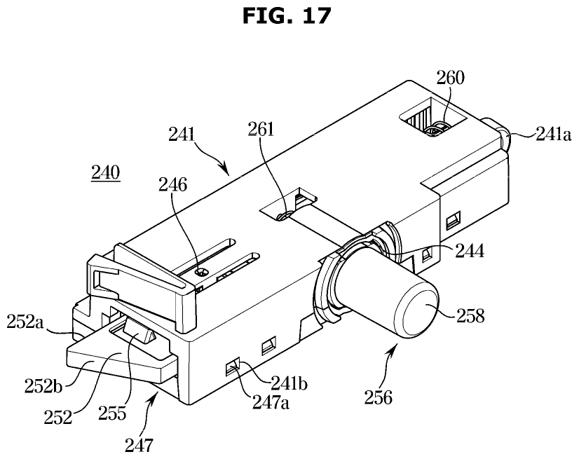

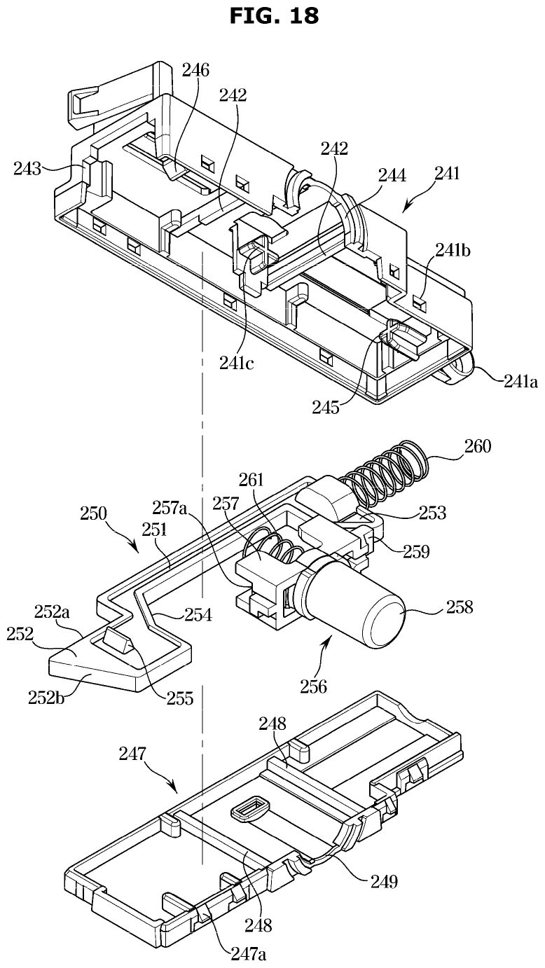

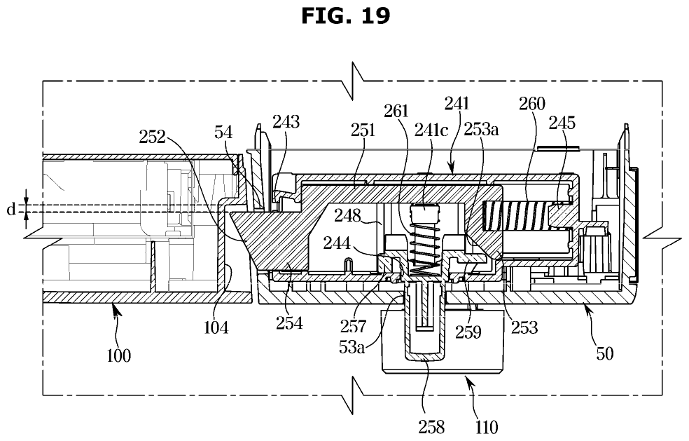

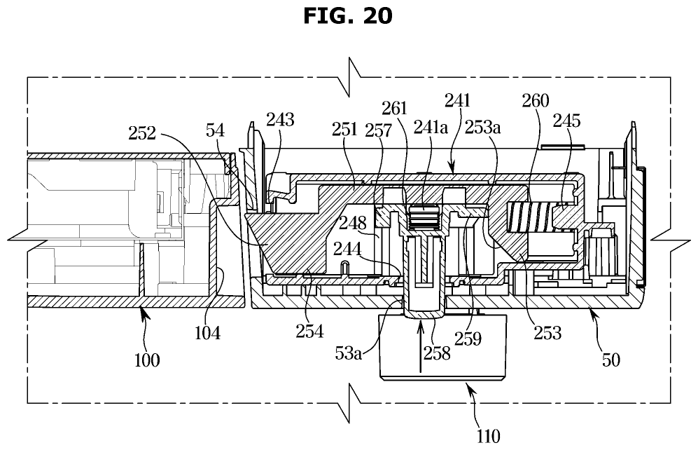

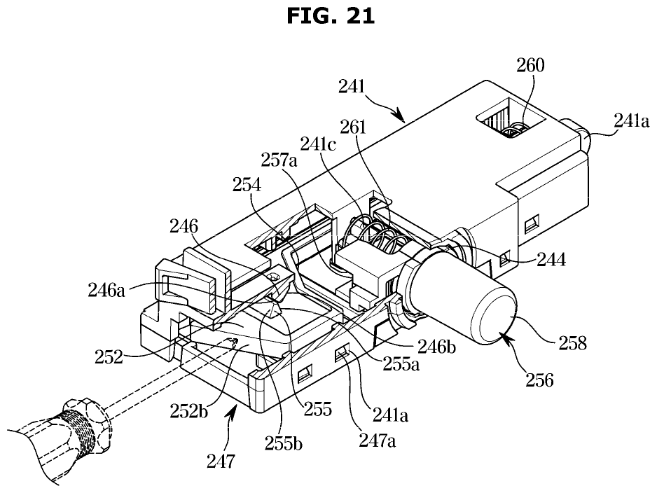

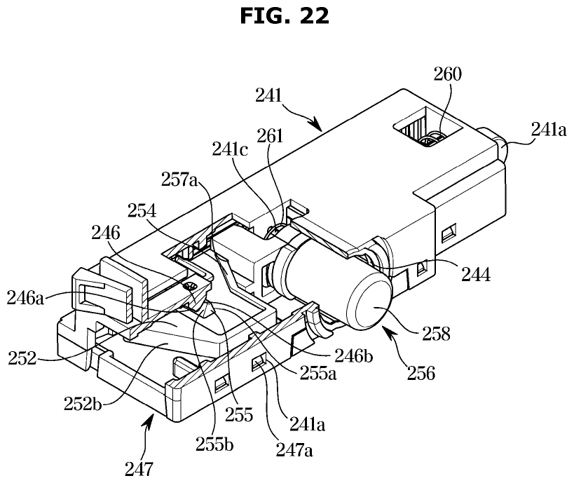

FIG. 17 illustrates a door lock according to an embodiment. FIG. 18 illustrates an exploded view of the door lock shown in FIG. 17. FIG. 19 illustrates a cross section of a state in which an interference member of the door lock shown in FIG. 18 is at an interference position. FIG. 20 illustrates a cross section of a state in which the interference member of the door lock shown in FIG. 18 is at an interference release position. FIG. 21 illustrates a process of moving the interference member of the door lock shown in FIG. 18 to a function release position. FIG. 22 illustrates a state in which the interference member of the door lock shown in FIG. 18 is at the function release position.

A door lock 240 of the cooking apparatus 1 according to an embodiment will be described with reference to FIGS. 17 to 22. The door lock 240 may be provided to limit the opening of the door 100. When a position at which the door 100 closes the cooking chamber 20 is referred to as a closed position and a position at which the door 100 opens the cooking chamber 20 is referred to as an open position, the door lock 240 may interfere the door 100 so as to allow the door 100 to be positioned at a limit position between the closed position and the open position.

The door 100 may include a door guide 104 formed to allow the opening of the door 100 to interfere with the door lock 240. The door guide 104 may be located at a portion of the door 100 facing the control panel 50 when the door 100 is in the closed position.

Referring to FIGS. 17 and 18, the door lock 240 may include a lock body 241. The lock body 241 may accommodate an interference member 250 to be movable. The lock body 241 may guide the movement of the interference member 250. The lock body 241 may accommodate a lever 256 to be movable. The lock body 241 may guide the movement of the lever 256. The lock body 241 may include a body fixer 241a for being fixed to the control panel 50. The lock body 241 may include a body coupler 241b for coupling with a lock cover 247. It is possible to define the lock cases 241 and 247 by including the lock body 241 and the lock cover 247.

The lock body 241 may include a body guide 242 provided to guide the movement of the lever 256. The body guide 242 may be located inside the lock body 241. The body guide 242 may protrude from an inner surface of the lock body 241. The body guide 242 may extend along a moving direction of the lever 256. The body guide 242 may be provided in plurality so as to support both side parallel to the moving direction of the lever 256.

The lock body 241 may include an interference member opening 243. The interference member opening 243 may be formed to allow at least a portion of the interference member 250 to pass therethrough. The interference member opening 243 may be located at a portion of the door lock 240 facing the door 100 when the door lock 240 is mounted on the control panel 50. The interference member opening 243 may be provided to correspond to an interference opening 54 (refer to FIGS. 19 and 20) formed in the control panel 50. The interference member opening 243 may guide the movement of the interference member 250.

The lock body 241 may include a lever opening 244. The lever opening 244 may be formed to allow at least a portion of the lever 256 to pass therethrough. The lever opening 244 may allow a manipulator 258 of the lever 256 to protrude to an exterior of the control panel 50. When the door lock 240 is mounted on the control panel 50, the lever opening 244 may be located at a portion of the door lock 240 facing forward. The lever opening 244 may be provided to correspond to a manipulation opening 53a (refer to FIGS. 19 and 20) formed in the control panel 50. The lever opening 244 may guide the movement of lever 256.

The lock body 241 may include an elastic body support 245. The elastic body support 245 may support an interference elastic body 260. The elastic body support 245 may be located at a first end of the lock body 241 that is opposite to a second end of the lock body 241 in which the interference member opening 243 is located. The elastic body support 245 may extend along a direction in which the interference elastic body 260 applies the elastic force to the interference member 250. The elastic body support 245 may protrude from the inner surface of the lock body 241. The elastic body support 245 may be provided to limit a movement in a direction perpendicular to the elastic force applied to the interference member 250 by the interference elastic body 260. The elastic body support 245 may be provided to support a first end of the interference elastic body 260 that is opposite to a second end of the interference elastic body 260 in which the interference elastic body 260 supports the interference member 250.

The lock body 241 may include a release supporter 246. The release supporter 246 may protrude toward the inside of the lock body 241. The release supporter 246 may extend from the inner surface of the lock body 241 toward the inside. The release supporter 246 may be provided to interfere with a release interference member 255 of the interference member 250. The release supporter 246 may protrude toward the interference member 250. The release supporter 246 may be arranged adjacent to the second end of the lock body 241 in which the interference member opening 243 is located. The release supporter 246 may be provided to be deformable.

The door lock 240 may include the lock cover 247. The lock cover 247 may cover one open side of the lock body 241. The lock cover 247 may include a cover coupler 247a for coupling with the lock body 241. The cover coupler 247a may be coupled to the body coupler 241b of the lock body 241.

The lock cover 247 may include a cover guide 248 provided to guide the movement of the lever 256. The cover guide 248 may be located inside the lock cover 247. The cover guide 248 may protrude from an inner surface of the lock cover 247. The cover guide 248 may extend along the moving direction of the lever 256. The cover guide 248 may be provided in plurality so as to support both side parallel to the moving direction of the lever 256.

The lock cover 247 may include an opening guide 249. The opening guide 249 may be provided to correspond to the lever opening 244 of the lock body 241. The opening guide 249 may be provided to guide the movement of the lever 256. Together with the lever opening 244, the opening guide 249 may be provided to guide the movement of the manipulator 258 of the lever 256.

The door lock 240 may include the interference member 250 movably accommodated inside the lock body 241. At least one portion of the interference member 250 may be provided to protrude to an exterior of the lock body 241. The interference member 250 may move to an interference position arranged to interfere with the opening of the door 100 or an interference release position arranged not to interfere with the door 100 to allow the door 100 to be opened. The interference member 250 may move to the interference position arranged to interfere with the opening of the door 100 or the interference release position arranged to release the interference of the door 100.

A first end of the interference member 250 may be supported by the interference elastic body 260. The interference member 250 may be elastically supported by a first end of the interference elastic body 260 opposite to a second end of the interference elastic body 260, which is supported by the lock body 241. By the interference elastic body 260, the interference member 250 may receive an elastic force in a direction of being separated from the lock body 241. The interference elastic body 260 may apply the elastic force to the interference member 250 in a direction in which the interference member 250 moves from the interference release position to the interference position.

The interference member 250 may include an interference member body 251 extending along the moving direction of the interference member 250. A door interference member 252 may be provided at an end of the interference member body 251. The door interference member 252 may be located at the end of the interference member body 251 adjacent to the door 100 when the door lock 240 is mounted on the control panel 50. The door interference member 252 may be provided to pass through the interference member opening 243. The door interference member 252 may be provided to pass through the interference opening 54. When the interference member 250 is at the interference position, at least a portion of the door interference member 252 may be accommodated inside the door guide 104. When the door interference member 252 is at the interference position and the door 100 is at the limit position, the door guide 104 may be come into contact with the door interference member 252 and may be supported by the door interference member 252.

The door interference member 252 may include a door interference surface 252a formed to interfere with the door 100 when the door 100 is opened. When the interference member 250 is at the interference position, the door interference surface 252a may be in contact with the door guide 104 formed on the door 100 and may limit the opening of the door 100. When the door 100 is opened while the interference member 250 is at the interference position, the door interference surface 252a may support the door guide 104 of the door 100 and prevent the opening of the door 100.

The door interference member 252 may include a door guide surface 252b that guides the movement of the door 100 without interfering with the door 100 when the door 100 moves from the open position to the limit position or the closed position. The door guide surface 252b may be inclined in a direction away from the door 100 as the door 100 is opened. The door guide surface 252b may be pressed by the door 100 when the door 100 moves from the open position to the limit position or the closed position, and thus the interference member 250 may move toward the inside of the lock body 241.

The interference member 250 may include an insertion guide 253 provided to be pressed by the lever 256. The insertion guide 253 may be located at the first end of the interference member 250 opposite to the second end of the interference member 250, in which the door interference member 252 is located. The insertion guide 253 may be arranged adjacent to the interference elastic body 260. The insertion guide 253 may be pushed by the lever 256 when the lever 256 is moved to move the interference member 250 from the interference position to the interference release position. As the insertion guide 253 is pushed by the lever 256, the interference member 250 may be moved from the interference position to the interference release position.

The door lock 240 may include an inclined insertion surface 253a inclined to convert a force caused by the movement of the lever 256 into a force for moving the interference member 250. The inclined insertion surface 253a may be inclined with respect to the moving direction of the lever 256. The inclined insertion surface 253a may be inclined with respect to the moving direction of the interference member 250. The inclined insertion surface 253a may be formed to be inclined toward the direction in which the interference member 250 moves from the interference release position to the interference position as the lever 256 is pushed when the interference member 250 is at the interference position. The inclined insertion surface 253a may be formed to allow the interference member 250 to move from the interference position to the interference release position as the manipulator 258 of the lever 256 is pressed to the inside of the lock body 241.

The inclined insertion surface 253a may be formed on the interference member 250. The insertion guide 253 may be pressed by an insertion pusher 259. Because the interference member 250 includes the inclined insertion surface 253a formed to be inclined and the lever 256 includes the insertion pusher 259, the direction of the force according to the movement of the lever 256 may be changed and thus it is possible to move the interference member 250.

Alternatively, the inclined insertion surface 253a may be formed on the lever 256. In the same manner as the inclined insertion surface 253a of the insertion guide 253, the insertion pusher 259 may be formed to convert a force caused by the movement of the lever 256 into a force for moving the interference member 250.

The interference member 250 may include a withdrawal guide 254 provided to be pressed by the lever 256. The withdrawal guide 254 may be positioned adjacent to a second end of the interference member 250 in which the door interference member 252 is located. The withdrawal guide 254 may be arranged adjacent to the door interference member 252. The withdrawal guide 254 may be pushed by the lever 256 when the lever 256 is moved to move the interference member 250 from the function release position to the interference release position or the interference position. As the withdrawal guide 254 is pushed by the lever 256, the interference member 250 may be moved from the function release position to the interference release position or the interference position.

The withdrawal guide 254 may be formed to be inclined with respect to the moving direction of the lever 256. The withdrawal guide 254 may be formed to be inclined with respect to the moving direction of the interference member 250. The withdrawal guide 254 may be inclined toward the direction in which the interference member 250 is moved from the interference position to the interference release position as the lever 256 is pushed when the interference member 250 is at the function release position. The withdrawal guide 254 may be inclined in a direction different from that of the insertion guide 253. The withdrawal guide 254 may be formed to allow the interference member 250 to move from the function release position to the interference release position as the manipulator 258 of the lever 256 is pressed toward the inside of the lock body 241. The withdrawal guide 254 may be provided to be pressed by a withdrawal pusher 257a of the lever 256.

The interference member 250 may include a release interference member 255 provided to interfere with the release supporter 246 of the lock body 241. The release interference member 255 may protrude from the interference member 250. The release interference member 255 may be arranged adjacent to the second end of the interference member 250 in which the door interference member 252 is located. The release interference member 255 may interfere with the release supporter 246 while the interference member 250 is moved between the interference release position and the function release position.

The door lock 240 may include the lever 256 provided to move the interference member 250. The lever 256 may be configured to be moved inside the lock body 241. The lever 256 may include a lever body 257. The lever body 257 may be arranged inside the lock body 241. The lever 256 may be moved in a direction substantially perpendicular to the moving direction of the interference member 250.

The lever body 257 may include the insertion pusher 259 provided to push the insertion guide 253. The insertion pusher 259 may press the insertion guide 253 while the interference member 250 is moved from the interference position to the interference release position. The lever 256 may include the withdrawal pusher 257a provided to push the withdrawal guide 254. The withdrawal pusher 257a may press the withdrawal guide 254 while the interference member 250 is moved from the function release position to the interference release position.

The lever 256 may include the manipulator 258 provided to protrude to an exterior of the door lock 240. The manipulator 258 may extend from the lever body 257. The manipulator 258 may be provided to pass through the lever opening 244. The manipulator 258 may be provided to pass through the manipulation opening 53a. The manipulator 258 may be provided to allow a user to operate the manipulator 258. The manipulator 258 may be exposed to the outside of the control panel 50. The lever 256 may be provided to be movable as the manipulator 258 is manipulated.

The door lock 240 may include the interference elastic body 260 provided to elastically support the interference member 250. The interference elastic body 260 may be mounted on the elastic body support 245. A first end of the interference elastic body 260 may be supported by the lock body 241. A second end of the interference elastic body 260 opposite to the first end of the interference elastic body 260 supported by the lock body 241 may be supported by the interference member 250.

The door lock 240 may include a lever elastic body 261 provided to elastically support the lever 256. The lever elastic body 261 may be mounted on a lever supporter 241c provided on the lock body 241. A first end of the lever elastic body 261 may be supported by the lock body 241. A second end of the lever elastic body 261 opposite to the first end of the lever elastic body 261 supported by the lock body 241 may be supported by the lever 256. The lever elastic body 261 may apply an elastic force to the lever 256 to a direction in which the lever 256 is separated from the lock body 241.

The interference position and the interference release position of the interference member 250 will be described with reference to FIGS. 19 and 20.

Referring to FIG. 19, the interference member 250 may be at the interference position that may interfere with the opening of the door 100. When the interference member 250 is at the interference position, the door 100 may be moved from the closed position to the limit position. When the interference member 250 is at the interference position, at least a portion of the door interference member 252 of the interference member 250 may be accommodated in the door guide 104. As the at least a portion of the door interference member 252 is accommodated in the door guide 104, the door 100 may interfere with the door lock 240 when the door 100 is moved from the closed position to the open position. When the door 100 is moved from the closed position to the open position, the door guide 104 of the door 100 may interfere with the door interference member 252 of the door lock 240.

Referring to FIG. 20, the interference member 250 may be at the interference release position for releasing the interference with the opening of the door 100. A user may move the interference member 250 to the interference release position by moving the manipulator 258 of the lever 256.

When the interference member 250 is at the interference release position, the door 100 may be moved from the closed position to the open position. When the interference member 250 is at the interference release position, the door interference member 252 of the interference member 250 may be separated from the door guide 104. When the interference member 250 is at the interference release position, the door interference member 252 of the interference member 250 may be moved into the lock body 241. As the door interference member 252 is separated from the door guide 104, the door 100 may not interfere with the door lock 240 when being moved from the closed position to the open position. When the door 100 is moved from the closed position to the open position, the door guide 104 of the door 100 may not interfere with the door interference member 252 of the door lock 240.

In a state shown in FIG. 20, when a user removes the force applied to the manipulator 258 of the lever 256, the lever 256 may be moved in the direction of being separated from the lock body 241 by the elastic force of the lever elastic body 261, and the interference member 250 may be moved in the direction of being separated from the lock body 241 by the elastic force of the interference elastic body 260. The manipulator 258 of the lever 256 may protrude to an exterior of the lock body 241 by the elastic force of the lever elastic body 261. The door interference member 252 of the interference member 250 may protrude to an exterior of the lock body 241 by the elastic force of the interference elastic body 260.

With the configuration, in the cooking apparatus 1 according to an embodiment, the opening of the door 100 may be limited by the door lock 240 even when the locking of the door 100 is released as the opening and closing device 120 is operated due to the movement of the button 110. Accordingly, it is possible to increase the safety of use. The cooking apparatus 1 according to an embodiment may unlock the door 100 by operating the opening and closing device 120 by moving the button 110 and then separate the door interference member 252 of the interference member 250 from the door guide 104 by moving the manipulator 258 of the lever 256 of the door lock 240, thereby opening the door 100. Accordingly, it is possible to increase the safety of use. In the cooking apparatus 1 according to an embodiment, because the door 100 is double-locked by the opening and closing device 120 and the door lock 240, it is possible to increase the safety of use.

As the force applied to the manipulator 258 of the lever 256 is removed, the door 100 is moved from the open position to the limit position or the closed position while the interference member 250 is at the interference position. At this time, the door 100 may be moved while pushing the door interference member 252 of the interference member 250 of the door lock 240. When the door 100 is moved from the open position to the limit position or the closed position while the interference member 250 is at the interference position, the door 100 may be moved by being in contact with the door guide surface 252b of the door interference member 252. When the door 100 is moved from the open position to the limit position or the closed position while the interference member 250 is at the interference position, the door interference member 252 may be pressed by the door 100 and moved to the inside of the lock body 241. After the door 100 is moved from the open position to the limit position or the closed position, the interference member 250 may be moved to the interference position by the elastic force of the interference elastic body 260.

With the configuration, the cooking apparatus 1 according to an embodiment may prevent the movement of the door 100 from being limited by the door lock 240 while moving from the open position to the limit position or the closed position.

The function release position of the interference member 250 of the door lock 240 will be described with reference to FIGS. 21 and 22. The interference member 250 of the door lock 240 may be moved to the function release position in which the door interference member 252 is fixed to the inside of the lock body 141 so as not to protrude to an exterior of the lock body 241.

Referring to FIG. 21, when a user does not want to double lock the door 100 by using the opening and closing device 120 and the door lock 240, the user can operate the door lock 240 to release the function of the door lock 240. A user can press the interference member 250 to a direction toward the inside of the lock body 241 by using a tool such as a screwdriver. From the interference release position, the interference member 250 may be further moved to a direction opposite to the interference position. The interference member 250 may be moved from the interference release position to the function release position. While the interference member 250 is moved from the interference release position to the function release position, the release interference member 255 of the interference member 250 may interfere with the release supporter 246 of the lock body 241. While the interference member 250 is moved from the interference release position to the function release position, the first interference surface 255a of the release interference member 255 may be in contact with the first support surface 246a of the release supporter 246. Because the release supporter 246 is deformable, the release interference member 255 may deform the release supporter 246 and may be moved in a direction in which the interference elastic body 260 contracts.

Referring to FIG. 22, when the release interference member 255 is moved until the first interference surface 255a of the release interference member 255 is released from contact with the first support surface 246a of the release supporter 246, the deformed release supporter 246 may be restored to its original state. As the release supporter 246 is restored, the second interference surface 255b of the release interference member 255 may come into contact with the second support surface 246b of the release supporter 246. The second interference surface 255b of the release interference member 255 may be supported on the second support surface 246b of the release supporter 246. The release supporter 246 may support the release interference member 255 to a direction opposite to the direction in which the interference member 250 protrudes to an exterior of the lock body 241. As the release supporter 246 supports the release interference member 255, the interference member 250 may maintain the function release position.

When a user wants to use the released function of the door lock 240 again, the user can operate the manipulator 258 of the lever 256 of the door lock 240 to move the interference member 250 from the function release position to the interference release position. The user may apply a force to the manipulator 258 of the lever 256 to allow a force, which is greater than a force with which the release supporter 246 supports the release interference member 255, to be applied to the interference member 250. As the user presses the manipulator 258 of the lever 256, the lever 256 is moved into the lock body 241. As the lever 256 is moved into the lock body 241, the withdrawal pusher 257a presses the withdrawal guide 254. Due to the inclined shape of the withdrawal guide 254, the interference member 250 may be moved to the interference release position. A direction of the force according to the movement of the lever 256 may be changed by the inclined shape of the withdrawal guide 254 and thus it is possible to move the interference member 250.

While the interference member 250 is moved from the function release position to the interference release position, the release supporter 246 may be deformed by the release interference member 255. When the release interference member 255 is moved until the second interference surface 255b of the release interference member 255 is released from contact with the second support surface 246b of the release supporter 246, the deformed release supporter 246 may be restored to its original state. The interference member 250 may be moved to the interference position by the elastic force of the interference elastic body 260.

With the configuration, the cooking apparatus 1 may selectively use the function of the door lock 240, and thus convenience of use may be improved.

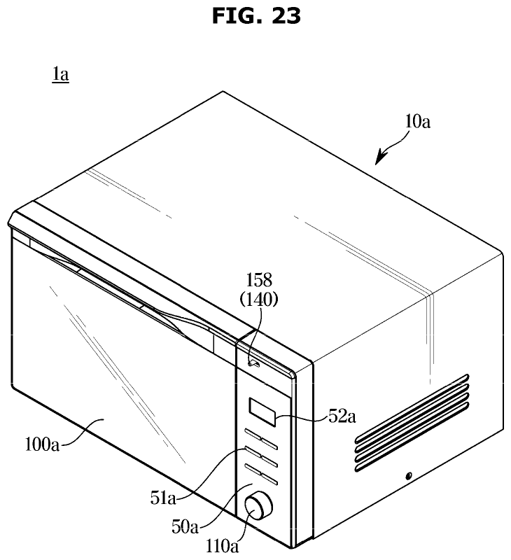

FIG. 23 illustrates a cooking apparatus according to an embodiment.

Referring to FIG. 23, a cooking apparatus 1a may include a main body 10a and a door 100a coupled to the main body 10a. The door 100 of the cooking apparatus 1 shown in FIG. 1 may be rotatably coupled to the left end of the main body 10, but the door 100a of the cooking apparatus 1a shown in FIG. 23 may be rotatably coupled to a lower end of the main body 10a. A configuration of a control panel 50a, an inputter 51a, a display 52a, and a button 110a of the cooking apparatus 1a shown in FIG. 23 may be the same as the configuration of the control panel 50, the inputter 51, the display 52, and the button 110 of the cooking apparatus 1 shown in FIG. 1. A door lock 140 of the cooking apparatus 1a shown in FIG. 23 may be the same as the door lock 140 of the cooking apparatus 1 shown in FIG. 1. Referring to FIG. 23, a manipulator 158 of the door lock 140 may protrude from the control panel 50a.

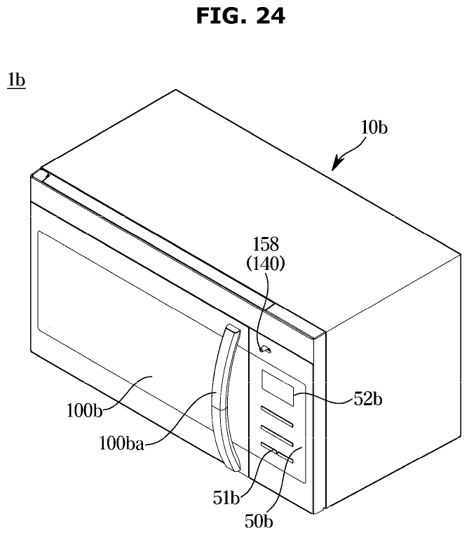

FIG. 24 illustrates a cooking apparatus according to an embodiment.

Referring to FIG. 24, a cooking apparatus 1b may include a main body 10b and a door 100b coupled to the main body 10b. The door 100 of the cooking apparatus 1 shown in FIG. 1 may be opened by manipulating the button 110, but the door 100b of the cooking apparatus 1b shown in FIG. 24 may be opened by applying a force to a handle 100ba. A configuration of a control panel 50b, an inputter 51b, and a display 52b of the cooking apparatus 1b shown in FIG. 24 may be the same as the configuration of the control panel 50, the inputter 51, and the display 52 of the cooking apparatus 1 shown in FIG. 1. A door lock 140 of the cooking apparatus 1b shown in FIG. 24 may be the same as the door lock 140 of the cooking apparatus 1 shown in FIG. 1. Referring to FIG. 24, a manipulator 158 of the door lock 140 may protrude from the control panel 50b.

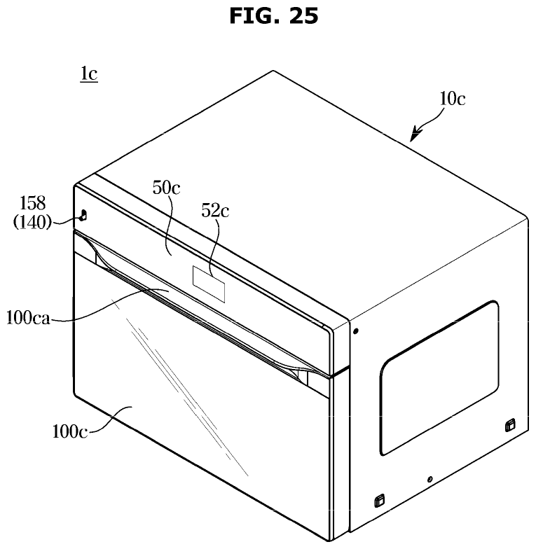

FIG. 25 illustrates a cooking apparatus according to an embodiment.

Referring to FIG. 25, a cooking apparatus 1c may include a main body 10c and a door 100c coupled to the main body 10c. The door 100 of the cooking apparatus 1 shown in FIG. 1 may be opened by manipulating the button 110, and rotatably coupled to the left end of the main body 10, but the door 100c of the cooking apparatus 1c shown in FIG. 25 may be opened by applying a force to a handle 100ca and rotatably coupled to a lower end of the main body loc. Referring to FIG. 25, a display 52c may be provided on a control panel 50c. The control panel 50c may be positioned above the door 100c. A door lock 140 of the cooking apparatus 1c shown in FIG. 25 may be the same as the door lock 140 of the cooking apparatus 1 shown in FIG. 1. The door lock 140 shown in FIG. 25 may be arranged in a state in which the door lock 140 shown in FIG. 1 is rotated by approximately 90°. Referring to FIG. 25, a manipulator 158 of the door lock 140 may protrude from the control panel 50c.

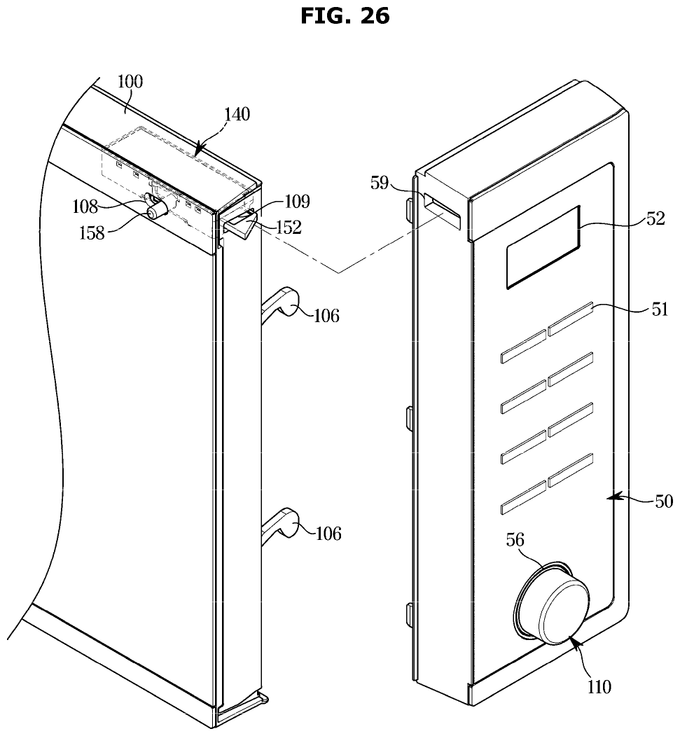

FIG. 26 illustrates a cooking apparatus according to an embodiment.

Referring to FIG. 26, a door lock 140 may be arranged on a door 100. A configuration of the door lock 140 shown in FIG. 26 may be the same as the configuration of the door lock 140 shown in FIG. 7. The door 100 may include a manipulation opening 108 formed to allow a manipulator 158 of the door lock 140 to protrude to the outside. The door 100 may include an interference opening 109 formed to allow a door interference member 152 of the door lock 140 to protrude to the outside. A configuration of an inputter 51, a display 52, and a button mounting member 56 of a control panel 50 shown in FIG. 26 may be the same as the configuration of the inputter 51, the display 52, and the button mounting member 56 of the control panel 50 shown in FIG. 7. The control panel 50 shown in FIG. 26 may include a panel guide 59 formed to accommodate the door interference member 152 of the door lock 140.

As is apparent from the above description, a cooking apparatus may open a door by operating a door lock and thus it is possible to increase the safety of use.

A cooking apparatus may selectively release a function of a door lock and thus it is possible to increase convenience of use.

Although a few embodiments of the disclosure have been shown and described, it would be appreciated by those skilled in the art that changes may be made in these embodiments without departing from the principles and spirit of the disclosure, the scope of which is defined in the claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A cooking apparatus, comprising:
a main body forming a cooking chamber;
a door configured to open and close the cooking chamber; and
a door lock comprising an interference member configured to interfere with a movement of the door while opening the cooking chamber; and a lock case configured to accommodate the interference member so as to be movable therein;
wherein the interference member is configured to move to an interference position for applying an interference with opening the door, an interference release position for releasing the interference of opening the door, and a function release position for restricting the interference of opening the door, the function release position is a position in which the interference member is supported by the lock case and in which movement of the interference member is restricted to the interference release position and the interference position.

2. The cooking apparatus of claim 1, wherein the door lock comprises a lever configured to move the interference member from the interference position to the interference release position.

3. The cooking apparatus of claim 2, wherein the lever is configured to move the interference member from the function release position to the interference release position as a force is applied to the lever that is greater than a force of the lock case supporting the interference member and the force applied to the lever is transferred to the interference member in the function release position.

4. The cooking apparatus of claim 2, wherein:
the lever is configured to move in a moving direction different from a moving direction of the interference member, and
the door lock comprises an inclined insertion surface inclined with respect to the moving direction of the lever or the moving direction of the interference member so as to transfer the force applied to the lever to a force for moving the interference member.

5. The cooking apparatus of claim 4, wherein:
the lever is configured to push the interference member from the function release position to the interference release position as the force applied to the lever is greater than a force of the lock case supporting the interference member and the force applied to the lever is transferred to the interference member in the function release position, and
wherein the door lock comprises a withdrawal guide inclined with respect to the moving direction of the lever or the moving direction of the interference member so as to transfer the force applied to the lever to a force for moving the interference member.

6. The cooking apparatus of claim 4, wherein the door lock comprises a lever elastic body configured to apply an elastic force to the lever in a direction in which the lever is separated from the lock case.

7. The cooking apparatus of claim 2, wherein the lock case comprises a lever guide extending along a moving direction of the lever to guide the movement of the lever.

8. The cooking apparatus of claim 2, wherein:
the lock case comprises a lever opening configured to allow at least a portion of the lever to protrude to an exterior of the lock case, and
in a state in which the interference member is moved to the interference release position as the lever presses the interference member, the lever opening is configured to prevent the lever from moving in a direction in which the interference member is moved from the interference release position to the function release position.

9. The cooking apparatus of claim 1, wherein the door lock comprises an interference elastic body configured to apply an elastic force to the interference member to a direction in which the interference member is moved from the interference release position to the interference position.

10. The cooking apparatus of claim 1, wherein:
the lock case comprises a release supporter configured to support the interference member in response to the interference member being at the function release position, and
the interference member comprises a release interference member configured to be supported by the release supporter.

11. The cooking apparatus of claim 10, wherein the release supporter is pressed and deformed by the release interference member while the interference member is moved between the interference release position and the function release position.

12. The cooking apparatus of claim 1, wherein the door is configured to move to a closed position for closing the cooking chamber, an open position for opening the cooking chamber, and a limit position in which the door is supported by the interference member while the interference member is at the interference position.

13. The cooking apparatus of claim 12, wherein the interference member comprises a door guide surface configured to be pressed and moved by the door so as to allow the door to be moved while the door is moved from the open position to the limit position or the closed position.

14. The cooking apparatus of claim 12, wherein:
the lock case comprises an interference member opening configured to allow at least a portion of the interference member to protrude to an exterior of the lock case toward the door in response to the door being at the closed position, and
the interference member is configured to move from the interference release position to the function release position as the interference member is pressed through the interference member opening in a state in which the interference member is at the interference release position.

15. The cooking apparatus of claim 1, further comprising:
a door latch configured to move in the door;
a sensor configured to be in contact with the door latch;
a controller electrically connected to the sensor; and
a heating source electrically connected to the controller,
wherein the controller is configured to control the heating source to stop an operation of the heating source in response to the door latch being separated from the sensor as the door is opened.

16. A cooking apparatus, comprising:
a main body forming a cooking chamber;
a door configured to open and close the cooking chamber; and
a door lock comprising an interference member configured to interfere with a movement of the door while opening the cooking chamber; a lever configured to move the interference member; and a lock case configured to accommodate the interference member and the lever so as to be movable therein;
wherein the interference member is configured to move to an interference position for applying an interference with opening the door, an interference release position for releasing the interference of opening the door, and a function release position for restricting the interference of opening the door, the function release position is a position in which the interference member is supported by the lock case and in which movement of the interference member is restricted to the interference release position or the interference position, and
wherein the lever is configured to move the interference member from the function release position to the interference release position as a force applied to the lever is greater than a force of the lock case supporting the interference member and the force applied to the lever is transferred to the interference member in the function release position.

17. The cooking apparatus of claim 16, wherein the door lock comprises an interference elastic body configured to apply an elastic force to the interference member to a direction in which the interference member is moved from the interference release position to the interference position.

18. The cooking apparatus of claim 16, wherein:
the interference member comprises a release interference member configured to be supported by the lock case in response to the interference member being at the function release position, and
the lock case comprises a release supporter configured to be pressed and deformed by the release interference member while the interference member is moved between the interference release position and the function release position.

19. The cooking apparatus of claim 16, wherein:
the lock case comprises a lever opening configured to allow at least a portion of the lever to protrude to an exterior of the lock case, and
in a state in which the interference member is moved to the interference release position as the lever presses the interference member, the lever opening is configured to prevent the lever from moving in a direction, in which the interference member is moved from the interference release position to the function release position.

20. The cooking apparatus of claim 16, wherein:
the lock case comprises an interference member opening configured to allow at least a portion of the interference member to protrude to an exterior of the lock case toward the door in a state in which the door is at a closed position for closing the cooking chamber, and
the interference member is configured to move from the interference release position to the function release position as the interference member is pressed through the interference member opening in a state in which the interference member is at the interference release position.
